(19) United States
(12) Patent Application Publication
(10) Pub. No.: US 2003/0014888 A1
(43) Pub. Date: Jan. 23, 2003

(54) Object, vehicle, structure, or logo styled business card holder

(76) Inventor: Allen D. Hertz, Boca Raton, FL (US)

Correspondence Address: Allen D. Hertz, 12784 Tulipwood Circle, Boca Raton, FL, 33428, US

(21) Appl. No.: 09/911,648

(22) Filed: Jul. 23, 2001

(51) Int. Cl. G09F 1/10

(52) U.S. Cl. 40/124

(57) ABSTRACT

A business card holder is manufactured from a foil using an etching process and formed into the desired shape. The business card holder has a front facia, a bottom structure, and a rear supporting member. The front facia and the rear supporting member can include images to depicts the likeness of any of various objects such as vehicles, buildings, logos. The business card holder would be formed such that the business cards would rest between the front facia, a bottom, and the rear support. The rear support area can be taller than the business card to provide an exposed section that can be used for advertising, promotion, or any other additional applications. The business card holder can be raised using tabs to form stand offs, which may be in the likeness of objects respective to the images such as wheels and tires for a vehicle. The likeness can be further enhanced by additional half etching, through etching, or painting of features onto the foil. The images can be of vehicles such as automobiles, trucks, motorcycles, marine vessels, trains, aviation vehicles, emergency vehicles, cartoon vehicles, construction vehicles, military and space vehicles and the like. The images may include houses, buildings or other structures for promoting real estate persons, and the like. The images may be of logos for use within businesses.

### BACKGROUND OF THE INVENTION

1. Field of the Invention

The present invention relates generally to the field of business card holders, promotions and advertisements. More specifically, the present invention utilizes an etched foil which includes a front facia and a rear supporting member, whereby the front facia or rear supporting member, or both, may include the likeness, preferably including a silhouette outline, of an object or logo, such as for vehicles, houses, or other recognizable object for holding business cards. The artwork or formation of the business card holder can be used as a promotional means for the image portrayed.

2. Description of the Prior Art

Advertisers use many objects for advertising such as pens, license plate frames, printed adhesive materials (bumper stickers, etc.), flashlights, keychains, and the like.

Business card holders are available in many shapes and sizes. They are of injection molded plastic, vacuum formed plastic, wood, and other materials. In addition to holding business cards, business card holders can be used for decoration or advertising purposes.

People are known to have certain emotional attachments to vehicles, including automobiles, trucks, motorcycles, boats, planes, and the like. Expanding this list includes affiliated images such as those of race-cars, race-boats, military vehicles, and the like. Combining an image of a vehicle with a respective known driver such as a race-car driver and his/her respective race-car artwork further enhances for a desirable product.

Etching of metals is known as a manufacturing method for making various objects of usefulness, displays or artwork. The etching process may be of chemical etching as described in Hertz (U.S. Pat. No. 6,202,918, issued Mar. 20, 2001). An alternate etching process that is known is laser etching. Both etching processes are capable of cutting partially through or entirely through the material in a precise and repeatable manner. These processes are known to be used to manufacture etched metal stencils for solder screen-printing processes for electronics manufacturing.

Printing ink onto metals is well known. One such means uses Tampo™ printing provides a method for printing fine details in multiple colors with accurate registration. Tampo™ printing transfers ink from a plate that is etched with the desired design to an object using a rubber transfer pad. By aligning multiple etched plates, one can transfer multiple colors while retaining a desirable registration.

Decals and other adhesives are well known as means to apply artwork to an object.

### SUMMARY OF THE INVENTION

The present invention provides a means to create a low cost business card holder that depicts the likeness of any of various vehicles, such as automobiles, trucks, motorcycles, trains, aviation vehicles, marine vessels, specialized vehicles, military vehicles, race-cars, space vehicles, and the like.

A first aspect of the present invention is the manufacture of a business card holder from an etched foil.

A second aspect of the present invention is the formation of a business card holder from an etched foil by bending the etched foil into a desirable shape, the shape comprising at least a front facia, a bottom surface, and a rear supporting member.

A third aspect of the present invention is the ability to etch through the foil to create a silhouette of the vehicle.

A forth aspect of the present invention is the inclusion of an etched area to assist in the bending of the etched foil into the desired shape to create said front facia, bottom surface, and rear supporting member.

A fifth aspect of the present invention is the use of small apertures as the etched area to assist in the bending of the etched foil.

A sixth aspect of the present invention is the use of a half etched area on a single surface as the etched area to assist in the bending of the etched foil.

A seventh aspect of the present invention is the use of a half etched area on both surfaces as the etched area to assist in the bending of the etched foil.

An eighth aspect of the present invention is the inclusion of half etched areas to provide details of said vehicle to the etched foil.

A ninth aspect of the present invention is the use of printed color(s) to provide details of said vehicle to the etched foil.

A tenth aspect of the present invention is the inclusion of nomenclature on the etched foil to add further identity to the etched business card colder.

An eleventh aspect of the present invention is the inclusion of the name of the vehicle in at least part of the nomenclature of the etched foil.

A twelfth aspect of the present invention is the inclusion of the name of the dealer of the vehicle in at least part of the nomenclature of the etched foil as a means for advertisement.

A thirteenth aspect of the present invention is whereby the artwork depicts a racecar and the nomenclature is of the respective race-vehicle driver's name, signature, likeness, number, or other identifying means.

A fourteenth aspect of the present invention is the placement of the likeness of the vehicle of a facing side of the foil and the placement of the likeness of the nomenclature on the opposing side of the foil; whereby when the foil is formed to the desired shape, the likeness of the vehicle and the likeness of the nomenclature can be viewed simultaneously.

A fifteenth aspect of the present invention is the inclusion of two additional side supporting members to ensure the business cards remain within the confines of the business card holder.

A sixteenth aspect of the present invention is the inclusion of tabs which are formed to be stand offs.

A seventeenth aspect of the present invention designs the stand-off tabs as cut outs from within the area which would become the bottom section of the business card holder.

An eighteenth aspect of the present invention designs the use of the stand-off tabs as wheels.

### BRIEF DESCRIPTION OF THE DRAWINGS

Various other objects, advantages. and features of the invention will become apparent to those skilled in the art from the following discussion taken in conjunction with the following drawings, in which:

FIG. 1 is an isometric view of the preferred embodiment of the inventive business card holder, illustrating an automobile and hidden elements using broken lines.

FIG. 2 is a top view of the inventive business card holder of FIG. 1 in the pre-bent state.

FIG. 3 is a bottom view of the inventive business card holder of FIG. 1 in the pre-bent state illustrating a stepped oval etch pattern for assisting in the bending process.

FIG. 4 is a bottom view of the inventive business card holder of FIG. 1 in the pre-bent state illustrating a half etched score line for assisting in the bending process.

FIG. 5 is an isometric view of an alternate embodiment of the inventive business card holder, illustrating a yacht.

### DETAILED DESCRIPTION OF THE PREFERRED EMBODBDENTS

As required, detailed embodiments of the present invention are disclosed herein; however, it is to be understood that the disclosed embodiments are merely exemplary of the invention that may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Reference is now made to the drawings, wherein the characteristics and features of the present invention shown in the various figures are designated by the same reference numerals.

### DETAILED DESCRIPTIONS

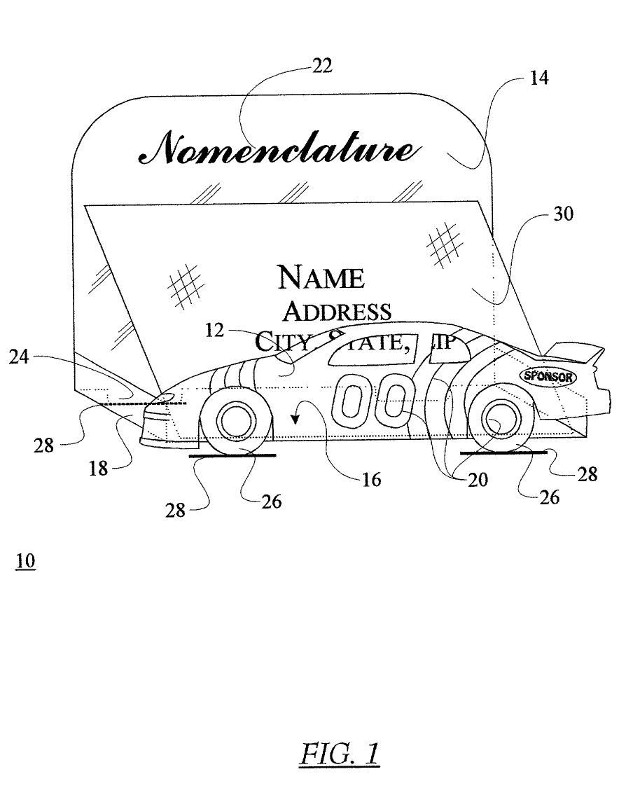

Referring to FIG. 1, a business card holder 10 is illustrated in an isometric view and disclosed as an apparatus for holding business cards 30. The business card holder 10 is illustrated including the likeness of a vehicle for a front facia 12, a rear supporting member 14, and a bottom structure 16. The business card holder 10 may further include side members 18. The business card holder 10 may further include artwork 20 to contribute additional details for improving the likeness of the vehicle. The artwork can be applied during the etching process (half-etched or through etched using chemicals, lasers, or other known processes), during a subsequent etching process, painting, Tampo™ printing process, silk screening process, decals, or any other known method for applying artwork. It is recognized by the Applicant that the preferred embodiment would present the front facia 12 as a silhouette of the vehicle, but alternate embodiments would allow for the front facia 12 to be a standard layout and the artwork to define the likeness of the vehicle. An additional feature shown is the use of standard etched tabs 24 and design related etched tabs 26 as a means to provide stand offs for the business card holder 10, wherein the tabs 24 and 26 would provide contact points to the surface of an object 28, such as a desk. The business card holder 10 may include advertisements such as sponsors names or other nomenclature 22. A preferred embodiment, placing the nomenclature 22 on the rear supporting member 14 in a position where it would be visible above the business cards 30. Details on how the nomenclature 22 is manufactured to the desirable position are described further within this specification.

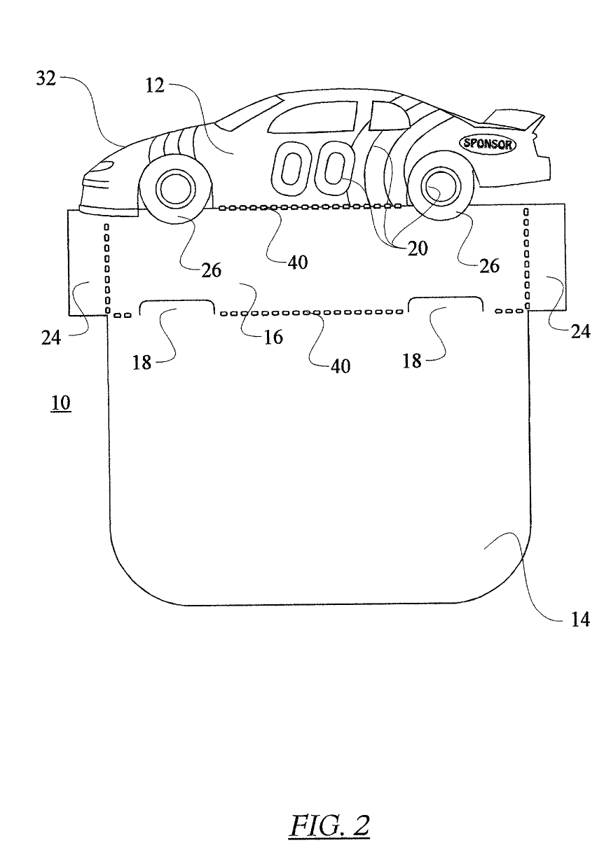

FIG. 2 illustrates a top view of the business card holder 10 in a post etched, prebent state and provides some definition of the manufacturing process. The business card holder 10 can be manufactured from a stainless steel foil that is cold rolled to 0.010″ thick and polished prior to etching. It can be recognized that other materials and thicknesses may be used. The Applicant has found this material and thickness to be sturdy, yet capable of accepting the bending process. In the illustration, the business card holder 10 includes features such as a series of apertures 40 for assisting with the bending process. A desirable geometry for the apertures would be a rectangle of 0.0344″×0.057″, with rounded corners on a pitch of 0.100″. The series of apertures can be used to define the features of the business card holder 10, including the front facia 12, the rear supporting member 14, the bottom structure 16, and the side tabs 18. The foil material is then bent along the series of apertures 40 to transform the planar foil into the desirable shape and utility as illustrated in FIG. 1. One method of forming the business card holder 10 would be to use a bending brake with tooling to accommodate the tabs 24 and 26. A second method of forming the business card holder 10 would be to use a forming jig and press. In the preferred embodiment, the silhouette of the vehicle is etched to create a portion of the outline 32 of the business card holder 10. The artwork 20 is applied to the foil material using any of known half etching processes to improve the likeness of the vehicle. The etching process can cut lines through the foil material to provide a means to create features such as standard etched tabs 24 and design related etched tabs 26. These features would remain planer to the front facia 12 or rear supporting member 14 to create stand offs.

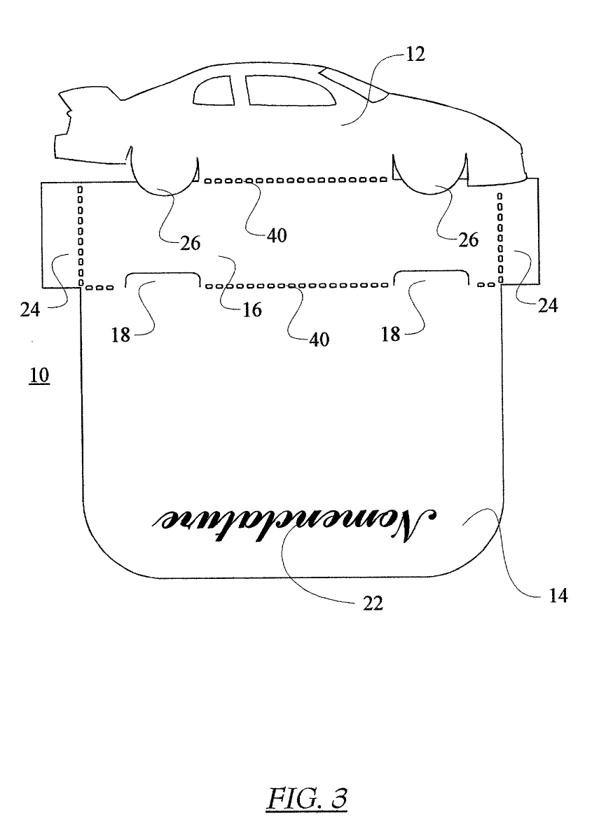

FIG. 3 illustrates a bottom view of the business card holder 10 in a post etched, pre-bent state and provides additional definition of the manufacturing process. The bottom view illustrates the nomenclature 22 or any other feature that would be desired on the rear supporting member 14 of the business card holder 10. The desired information such as nomenclature 22 would be half etch, printed or other means onto the bottom side of the foil material in the desired location. When the rear supporting member 14 is bent into position, the image (nomenclature 22) is then visible from the front viewing position as shown in FIG. 1. The nomenclature 22 is correct reading whereas an image of the vehicle is a mirror image compared to the top view. Artwork 20 is not shown in the bottom view, nor is it required as it would not be visible. Features that would be etched through the foil material are shown, such as windows, areas to define wheels, and the series of apertures 40. It can be recognized that such features would vary depending upon the vehicle depicted and manufacturers artistic preferences.

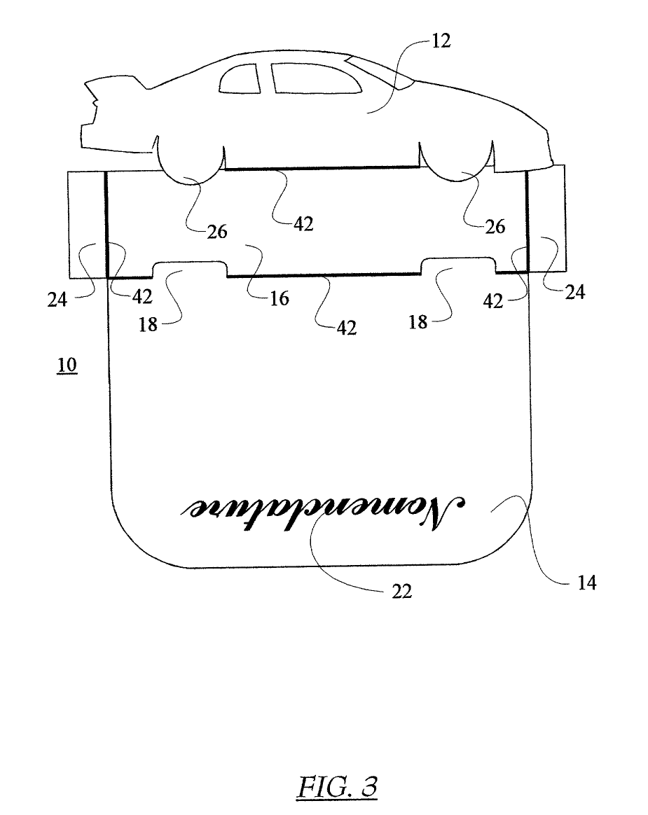

FIG. 4 illustrates an alternative to the series of apertures (reference item 40 of FIG. 2 and FIG. 3), by creating a half etched line 42 to identify and aid with the forming process. The half etched line 42 can be on either one side or both sides of the foil material. To clarify, the verbiage of “half etching” would be the removal of material from the foil material, but not through, which can be any percentage greater than, but not equal to 0% but less than and not equal to 100% of the thickness of the foil material. If the line were to be half etched on both sides of the foil material, the sum of both etchings would be any percentage greater than, but not equal to 0% but less than and not equal to 100% of the thickness of the foil material. The preferred embodiment would have a target of etching 50% of the material.

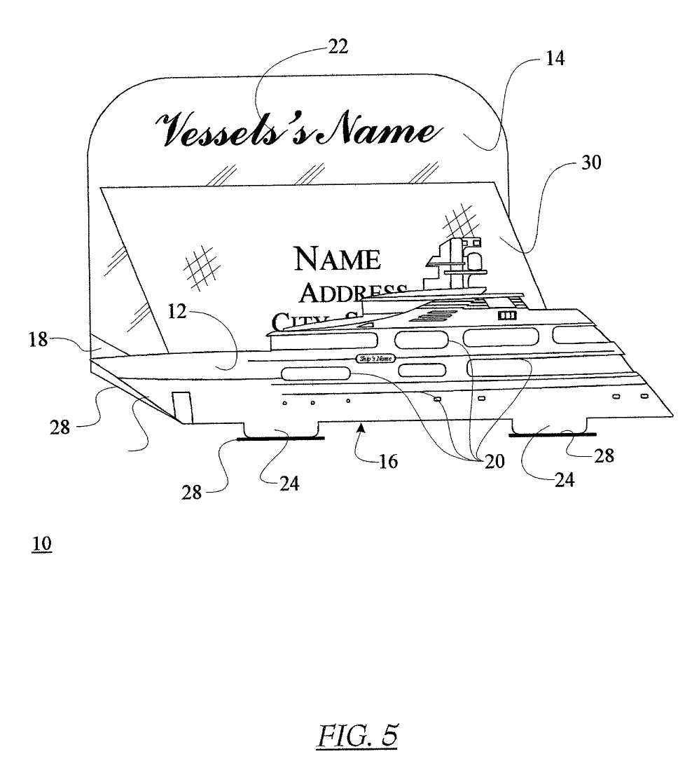

FIG. 5 illustrates an alterative embodiment of the present invention, presenting an image of a marine vessel as the image for the front facia 12. The etched tabs 24 can be of any shape as shown, or design to be incorporated as a feature for the image. The illustration identifies the similar features of FIG. 1, using the same references.

The illustrations of FIG's. 1-4 herein depict a business card holder 10 with the likeness of a race-car. It can be recognized that the vehicles can vary as identified herein, as shown in FIG. 5. The nomenclature 22 can be of items such as a dealerships name, a race-car driver's signature, the vehicles identity, a military troop ID, and the like. It can be further recognized that other items such as houses for real estate, Business Logo's, and the like can be placed on the front facia and/or rear supporting member.

### Method

In the manufacture of the present invention, the following method may be used. A foil material is etched to create an outline of the business card holder 10. Artwork 20 can be applied using an etching process, printing process, and the like. The same application process can be used to create the nomenclature 22. A means to assist in the forming process can be created by either etching a series of apertures 40, half etching a line 42, or other means. The business card holder 10 is then formed by bending the front facia 12 with respect to the bottom supporting structure 16 and bending the rear supporting member 14 with respect to the bottom supporting structure 16. If optional side tabs 18 are included, they can be formed by bending the side tabs 18 with respect to the bottom supporting structure 16. Stand offs can be created by etching tabs 24 and 26 into the foil material and providing a clearance in the forming tooling such that the tabs remain planar respective to the front facia 12 and rear supporting member 14.

I claim as my invention:

1. A business card holder comprising a foil, wherein the foil is fabricated to include a likeness of at least one of an object, a vehicle, a logo, and a building, and formed to at least include
a front facia,
a bottom member, and a
a rear member.

2. The business card holder of claim 1, wherein the cardholder includes the likeness of the vehicle and the likeness of the at least one of an object, a vehicle, a logo, and a building is further enhanced by the inclusion of half etched artwork.

3. The business card holder of claim 1, wherein the cardholder includes the likeness of the at least one of an object, a vehicle, a logo, and a building and the likeness of the at least one of an object, a vehicle, a logo, and a building is located on the front facia.

4. The business card holder of claim 3, wherein the likeness of the at least one of an object, a vehicle, a logo, and a building is further enhanced by the inclusion of half etched artwork.

5. The business card holder of claim 3, wherein the business card holder further comprising etched tabs for stand-offs.

6. The business card holder of claim 5, wherein at least some of the etched tabs are included as a portion of the likeness of the at least one of an object, a vehicle, a logo, and a building.

7. The business card holder of claim 3, wherein the likeness of the at least one of an object, a vehicle, a logo, and a building is further enhanced by application of at least one of ink, paint, dye, ceramic and adhesive.

8. The business card holder of claim 3, wherein the foil includes an at least partial removal of material along at least a portion of the bending line, whereby the removal of material is to aid in the bending process of the foil.

9. A business card holder comprising a foil, wherein the foil is fabricated to include the likeness of at least one of an object, a vehicle, a logo, and a building, and formed to at least include
a front facia,
a rear supporting member,
wherein at least one of the front facia and the rear supporting member are in the silhouette of the at least one of an object, a vehicle, a logo, and a building, and a
a bottom member.

10. The business card holder of claim 9, wherein the likeness of the at least one of an object, a vehicle, a logo, and a building is further enhanced by the inclusion of half etched artwork.

11. The business card holder of claim 9, the likeness of the at least one of an object, a vehicle, a logo, and a building is located on the front facia.

12. The business card holder of claim 9, wherein the likeness of the at least one of an object, a vehicle, a logo, and a building is further enhanced by the inclusion of half etched artwork.

13. The business card holder of claim 9, wherein the business card holder further comprises etched tabs for stand-offs.

14. The business card holder of claim 11, wherein at least some of the etched tabs are included as a portion of the likeness of the at least one of an object, a vehicle, a logo, and a building.

15. The business card holder of claim 9, wherein the likeness of the at least one of an object, a vehicle, a logo, and a building is further enhanced by application of at least one of ink, paint, dye, ceramic and adhesive.

16. A business card holder comprising a foil, wherein the foil is fabricated to include the likeness of a at least one of an object, a vehicle, a logo, and a building, and formed to at least include
a front facia,
a bottom member, and a
a rear member, whereby the rear member is at least taller than a standard business card to provide an area for additional artwork.

17. The business card holder of claim 16, wherein the likeness of the at least one of an object, a vehicle, a logo, and a building is further enhanced by the inclusion of half etched artwork.

18. The business card holder of claim 16, the likeness of the at least one of an object, a vehicle, a logo, and a building is located on the front facia.

19. The business card holder of claim 18, wherein the likeness of the at least one of an object, a vehicle, a logo, and a building is further enhanced by the inclusion of half etched artwork.

20. The business card holder of claim 17, wherein the business card holder further comprises etched tabs for stand-offs.

21. The business card holder of claim 20, wherein at least some of the etched tabs are included as a portion of the likeness of the at least one of an object, a vehicle, a logo, and a building.

22. The business card holder of claim 16, wherein the likeness of the at least one of an object, a vehicle, a logo, and a building is further enhanced by application of at least one of ink, paint, dye, ceramic and adhesive.

23. A business card holder comprising a foil, wherein the foil is fabricated to include the likeness of the at least one of an object, a vehicle, a logo, and a building, and formed to at least include
a front facia,
a bottom member
a rear member, and
a two side members.

24. The business card holder of claim 23, wherein the likeness of the at least one of an object, a vehicle, a logo, and a building is further enhanced by the inclusion of half etched artwork.

25. The business card holder of claim 23, the likeness of the at least one of an object, a vehicle, a logo, and a building is located on the front facia.

26. The business card holder of claim 25, wherein the likeness of the at least one of an object, a vehicle, a logo, and a building is further enhanced by the inclusion of half etched artwork.

27. The business card holder of claim 25, wherein the business card holder further comprises etched tabs for stand-offs.

28. The business card holder of claim 27, wherein at least some of the etched tabs are included as a portion of the likeness of the at least one of an object, a vehicle, a logo, and a building.

29. The business card holder of claim 25, wherein the likeness of the at least one of an object, a vehicle, a logo, and a building is further enhanced by application of at least one of ink, paint, dye, ceramic and adhesive.

30. The business card holder of claim 25, wherein the foil includes an at least partial removal of material along at least a portion of the bending line, whereby the removal of material is to aid in the bending process of the foil.
